(19) United States
(12) Patent Application Publication
(10) Pub. No.: US 2012/0232918 A1
(43) Pub. Date: Sep. 13, 2012

(54) ELECTRONIC DATA CAPTURE, DOCUMENTATION, AND CLINICAL DECISION SUPPORT SYSTEM

(76) Inventors: Jonathan F. MACK, San Diego, CA (US); Enrique Saldivar, Santee, CA (US)

(21) Appl. No.: 13/290,009

(22) Filed: Nov. 4, 2011

Related U.S. Application Data
(60) Provisional application No. 61/410,803, filed on Nov. 5, 2010.
(60) Provisional application No. 61/410,793, filed on Nov. 5, 2010.
(60) Provisional application No. 61/454,896, filed on Mar. 21, 2011.
(60) Provisional application No. 61/488,334, filed on May 20, 2011.

(51) Int. Cl. G06Q 50/22

(52) U.S. Cl. 705/2

(57) ABSTRACT

An electronic data capture, documentation and clinical decision support system (EDDS) includes a user display and input device, where the device is configured to include symbolic language including icons, the icons being controllable based upon user input. Multiple input data feeds are provided from one or more external databases, and preferably from a user input device. A display presentation system cohorts or otherwise organizes the data received via the input data feeds. An external device control system serves to provide wireless remote control of medical devices. Optionally, a clinical decision support system for providing clinical information to the user, such as providing a diagnosis, suggested treatment, medication or other medical action. The recommended clinical action may be implemented automatically, or upon the further authorization of the medical professional.

### PRIORITY CLAIM

This application claims priority to U.S. Provisional Application No. 61/410,803, filed Nov. 5, 2010, entitled “Wireless Fetal Monitoring System” (Ref. 921,355-007), U.S. Provisional Application No. 61/410,793, filed Nov. 5, 2010, entitled “Electronic Data Capture, Documentation, and Clinical Decision Support System” (Ref. 921,355-006), U.S. Provisional Application No. 61/454,896, filed Mar. 21, 2011, entitled “Prenatal Wireless Mobile Pack” (Ref. 921,355-023), and U.S. Provisional Application No. 61/488,334, filed May 20, 2011, entitled “Low-Cost Portable Fetal Monitor With Provisions for Multiple Births” (Ref. 921,355-024), all of which are incorporated herein by reference as if fully set forth herein.

### STATEMENT OF RELATED APPLICATIONS

This application is related to U.S. Published Patent Application 2011/0137209, Ser. No. 12/917,848, filed Nov. 2, 2010, entitled “Microphone Arrays for Listening to Internal Organs of the Body” (Ref. 921,355-004), U.S. patent application Ser. No. 13/094,678, filed Apr. 26, 2011, entitled “Ultrasound Patch” (Ref. 921,355-012), U.S. Patent Application Ser. No. 61/410,793, filed Nov. 5, 2010, entitled “Electronic Data Capture, Documentation and Clinical Decision Support System” (Ref. 921,355-006), and U.S. patent application Ser. No. 13/102,817, filed May 6, 2011, entitled “Multipurpose, Modular Platform for Mobile Medical Instrumentation” (Ref. 921,355-019), all of which are incorporated herein by reference as if fully set forth herein.

### FIELD OF THE INVENTION

The present invention relates to devices, systems and methods for provision of electronic medical records. More particularly, it relates to enhanced user interfaces and control for accessing, maintaining and using electronic medical records.

### BACKGROUND OF THE INVENTION

The United States has adopted a national strategy designed to move all health care systems/health care providers towards adopting an electronic medical record (EMR). An EMR is defined as “as an electronic patient record system dedicated to collecting, storing, manipulating, and making available clinical information important to the delivery of patient care to individuals or groups of patients. Such systems may be limited in their scope to a single area of clinical information (e.g., dedicated to laboratory data), or they may be comprehensive and cover virtually every facet of clinical information pertinent to patient care (see, e.g., Kohn Institute of Medicines Report: To Err Is Human: Building a Safer Health System”, 1997). The Office of the National Coordinator for Health Information Technology is directly responsible for this task with a goal of 2014 EMR adoption (Health Information 2010).

Health systems/health providers that employ an EMR, or will be migrating to an EMR, experience the following issues (Health Information 2010). First, numerous vendors without a standardized software platform for utilizing EMRs result in lack of interoperability between health care organizations. Second, there is no standardized language for EMRs or medical devices such as displays, Icons, colors or user interfaces. This lack potentially results in user errors when multiple devices or documentation standards exist. Third, current EMRs are enlarged spreadsheets that require users to tab and type information into cells which is time confusing and prone to errors. Current EMRs require users to scroll through multiple preformatted documentation pages regardless of the patient problem or documentation needs of the user.

EMRs are not constructed with advanced features such as critical event reporting, or smart chart ability for clinical decision support functions. They can only display data and not provide clinical decision support to the clinician. Fifth, beginning in 2011, the Centers for Medicare and Medicaid Services (CMS) have announced that any health agency or provider that implements and uses a certified EMR in their facilities, in a meaningful way (as defined by the U.S. Department of Health and Human Services), will receive bonus payments for billings conducted. In addition, hospitals and healthcare providers that do not implement CCHIT-certified EMRs by 2014 will have their Medicare reimbursement rates cut by up to 3 percent beginning in 2015. The U.S. Congressional Budget Office (CBO) estimates these incentives will persuade nearly 90 percent of U.S. physicians to use EMRs over the next 10 years.

Electronic medical records do not currently have the ability to control external devices such as infusions pumps, physiological monitoring, pharmaceutical dispensing, or direct observation devices such as video or audio capture of patient activities. Seventh, current EMRs lack the ability to control medical devices through the EMR user interface.

Organizations utilizing medical devices and electronic medical records lack a standardized user interface as well as cross platform sharing of data between originations utilizing different EMR types. Again, this potentially leads to user errors.

Finally, current EMRs are unable to receive data from remote monitoring sources for the purpose of storage, review, significance determination, or suggested action on the part of the user.

Epic Systems is currently one of the top selling EMRs in the United States. The basic architectural structure of Epic allows for data transfer and storage of clinically related information from multiple sources including direct input by user. Epic is interoperable across their proprietary platforms that link clinical, diagnostic imaging, medical record archive, billing, and clinical narrative documentation. Their product can be utilized on a variety of fixed and mobile devices (except small hand held devices) for documentation and all act as data repository for viewing by the clinician.

However, the Epic Systems product suffers from a lack of interoperability across non-proprietary platforms, which include other software/hardware architectural platforms and external medical devices, which do not use Epic's software architecture. Further, Epic employs a user interface that does not allow for efficiency for inputting data. EMR is not fully functional on mobile devices employing small screen sizes normally contained on mobile devices. Screens are static (predefined screens which require data to be input) and do not self configure to the user's needs. It functions as a data repository and data display only, and lacks the ability to review, summarize, create viewable narratives, generate clinical summaries, or provide the end user with a selection of suggested diagnosis or treatment strategies automatically.

More generally, a mobile device's display of clinical data (especially from multiple sources) is inherently restricted due to screen size and operating systems on these devices. Current EMR user interfaces are not capable of being displayed on small wireless devices. Current EMRs utilized on mobile devices only display static data.

The Epic product user interface employs predefined screens containing fields that require the user to tab through multiple screens (similar to a spreadsheet) and type information into each field. The EMR does not assist the clinician in defining the necessary documentation, but has numerous predefined screens that clinicians must transition through to locate the appropriate area to input data. Nor does the Epic system utilize standardized Icons, which are transferable to other devices other than a proprietary EMR, capable of carrying out predefined tasks such as data entry, operating other devices, which are electronically linked to the Icons.

Centricity from GE Healthcare shares a large share of the hospital EMR market in the United States. They also provide telemetry monitoring in ICUs that allow for patient documentation. The basic architectural structure of Centricity allows for data transfer and storage of clinically related information from multiple sources including direct input by user. Centricity EMR is capable of receiving data from multiple sources, downloading and displaying data in simple, definable formats. Data input by clinicians can be accomplished through both fixed and mobile devices (GE 2010).

However, the system lacks interoperability across non-proprietary platforms, which include other software/hardware architectural platforms and external medical devices, which do not use Centricity's software architecture. It also employs a user interface that does not allow for efficiency for inputting data. EMR is not fully functional on mobile devices employing small screen sizes normally contained on mobile devices. Screens are static (predefined screens which require data to be input) and do not self configure to the user's needs.

The Centricity system functions as a data repository and data display only and lacks the ability to review, summarize, create viewable narratives, generate clinical summaries, or provide the end user with a selection of suggested diagnosis or treatment strategies automatically.

Cerner company has been an industry standard for software systems including Cerner's EMR for many healthcare organizations in the U.S. They have products that are interoperable across multiple Cerner platforms that span inpatient and outpatient clinical settings. The basic architectural structure of Cerner allows for data transfer and storage of clinically related data from multiple sources including direct input by user. Cerner has a system that allows devices with Cerner proprietary software to connect and download information into their central EMR. Cerner's product can be utilized on a variety of fixed and mobile devices for documentation and all versions of their software act as data repository for viewing by the clinician (Cerner 2010).

However, the Cerner system lacks interoperability across non-proprietary platforms (which include other software/hardware architectural platforms and external medical devices, which do not use its software architecture. It employs a user interface that does not allow for efficiency for inputting data. EMR is not fully functional on mobile devices employing screen small screen sizes normally contained on mobile devices. Screens are static (predefined screens which require data to be input) and do not self configure to the user's needs. Further, it functions as a data repository and data display only and lacks the ability to review, summarize, create viewable narratives, generate clinical summaries, or provide the end user with a selection of suggested diagnosis or treatment strategies automatically.

Despite the clear desirability and mandated inevitability of EMRs, not optimal solution has yet to be produced. Accordingly, a need exists for an improved electronic data capture, documentation and clinical decisions support system.

### SUMMARY OF THE INVENTION

The electronic data capture, documentation, and user assistance device utilizes a device user interface based upon symbolic language on a software architecture that allows other electronic documentation systems to operate on the platform. It employs Icons which are touch or stylus gesture input on a computerized touch sensitive screen or other user input device. The system can be deployed on any medical or mobile communications device. The system captures data through multiple sources including direct user input, data transferred electronically via any source (or data type including numerical, demographic, graphical, video, or audio) and cohorts or organizes the data based upon type prior to display for the user. The user interface allows the electronic medical record to control devices external to the electronic medical record as well as receive data from external sources and devices.

The system automatically or manually (through user direction) makes changes in operating parameters or functions to external devices automatically. The system also employs a smart technology that continuously scans data to interpret relationships, trending, or determine if critical events are occurring based upon algorithmic parameters (and user defined). The system will send electronic alerts automatically via multiple critical or significant events for the user with suggested options for user actions based upon that data. The user interface may be employed on any medical device creating a standardized user interface for any medical device.

The device is interoperable across EMRs and medical devices so as not to interfere with transfer of data. The software platform allows data to be imported from any database, EMRs, or medical devices for use by the clinician.

The system operates to visualize, input, and manage data, and carry out functions on a mobile or EMR platform. Symbolic language, such as in the form of Icons, are usable on any medical device or EMR. Icons are utilized to import data in preference to narrative documentation, and used as a method to control other devices, create user alerts, and define user actions.

EMRs and remote patient monitoring produce large volumes of data, which complicates the ability to visualize, analyze, and take action upon by the clinician. EMRs are inherently data driven, creating user problems for visualizing concepts (potential diagnoses) from various databases. This problem extends to medical devices that transmit data wirelessly to the end user. Software algorithms sort data and reviews for relationships. That data is then displayed to the end user (clinician) who sees a graphical display of relationships from various data sources, and preferably in combination, a suggested action or actions on the part of the clinician. Preferably, the system prompts the clinician through suggested diagnosis, treatments, medications, or medical actions.

Employing Icon based visualization of data and data input allows for applying EMR functions (input of clinical data, entering clinical orders, displaying clinical data) to the restricted screen space that is common on mobile devices. The system and methods cohorts data into short narratives or brief data summaries with suggested diagnosis, treatments, or clinical actions. This is done by use of clinical decision support software. Use of Icons for inputting data on a mobile device allows for improved visualization and ease of input by eliminating narrative typing of clinical data.

The system and methods serve to continuously scan clinical data downloaded from multiple sources contained in the databases to determine if there are subtle or significant changes occurring, which will require the user to take some type of action. They serve to control operations of other devices electronically including device parameter selections, functions (including on or off functions), or data retrieval and data manipulation. They further provide for wireless data analysis, storage, retrieval, or assistance to the clinician to determine medical actions, diagnosis, or treatments. Finally, they serve to retrieve data from multiple databases and integrate multiple pieces of discreet data into graphically displayed data, which represents interrelationships between data sets.

An electronic data capture, documentation and clinical decision support system (EDDS) includes a user display and input device, where the device is configured to include symbolic language including icons, the icons being controllable based upon user input. Multiple input data feeds are provided from one or more external databases, and preferably from a user input device. A display presentation system cohorts or otherwise organizes the data received via the input data feeds. An external device control system serves to provide wireless remote control of medical devices. Optionally, a clinical decision support system for providing clinical information to the user, such as providing a diagnosis, suggested treatment, medication or other medical action. The recommended clinical action may be implemented automatically, or upon the further authorization of the medical professional.

Accordingly, it is an object of these inventions to provide for an enhanced electronic data capture, documentation and clinical decision support system, especially one adapted for use in a wireless environment.

### BRIEF DESCRIPTION OF THE DRAWINGS

FIG. 1 is a schematic functional block diagram showing the ability of the device to accept data from outside sources including data bases remote monitoring, and manual entry, after data is received the system utilizes algorithms to determine recommended course of action by the clinician.

FIG. 2 is a schematic functional block diagram showing how gesture movement of Icon acts as controller for external devices such as wireless devices.

FIG. 3 is a flowchart functional block diagram showing the basic function of icons on a mobile platform.

FIG. 4 is a plan view of a representative patient dashboard.

FIG. 5 is a screen display of patient display information.

FIG. 6 is a display of a Clinical Documentation screen.

FIG. 7 is display of fetal heart rate and maternal contraction information, displayed as a function of time.

### DETAILED DESCRIPTION OF THE INVENTION

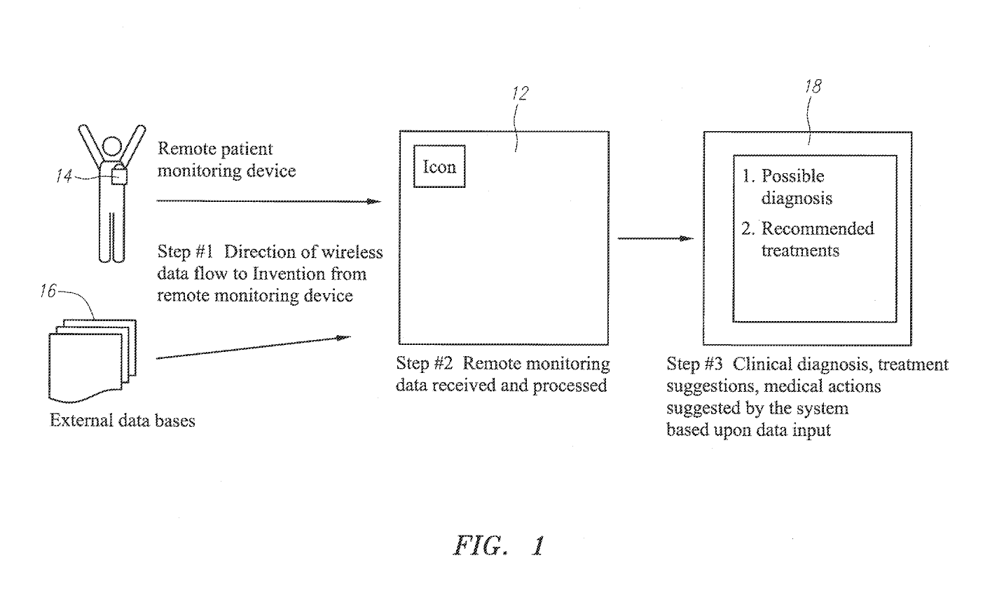

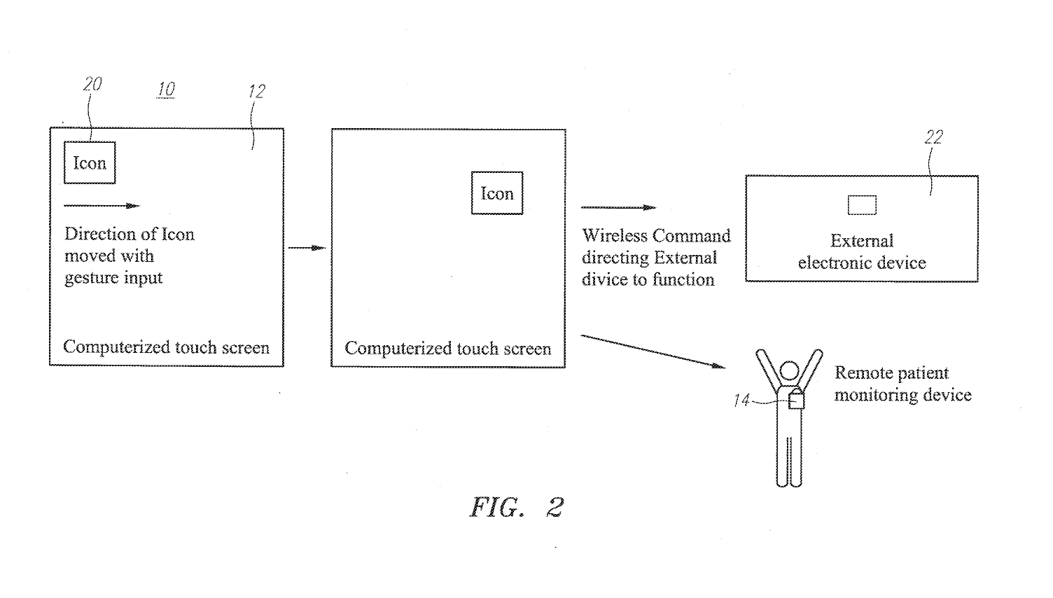

The systems and methods have three main components: a user interface, the data management and clinical decision system and a documentation tool. FIGS. 1 and 2 are schematic functional block diagrams showing the main components and their interrelation. FIG. 1 is a schematic functional block diagram showing the ability of the device to accept data from outside sources including data bases remote monitoring, and manual entry (step #1), after data is received (Step #2) the system utilizes algorithms to determine recommended course of action by the clinician (step #3). FIG. 2 is a schematic functional block diagram showing how gesture movement of Icon acts as controller for external devices such as wireless devices.

FIGS. 1 and 2 show the electronic data capture, documentation and clinical decision support system (EDDS) device 10, which includes display 12. Display 12 is preferably a touch screen to facilitate display and user interaction. The EDDS device 10 receives data from multiple sources, including but not limited to data from a remote patient monitoring device 14, external data bases 16, or via user (e.g., medical professional) input into the EDDS device 10, such as via the touch screen display 12. The input data is then processed, alone or in combination with other remote data, to provide clinical diagnosis, treatment suggestions, or other medical actions suggested by the system. (step 18). These may be implemented automatically, or only upon approval of the medical profession such as by providing approval input via the display 12. As shown in FIG. 2, the movement of the icon on the display 12 results in the issuance of a wireless command to external devices, including but not limited to an external electronic device 22 and/or a remote patient monitoring device 14.

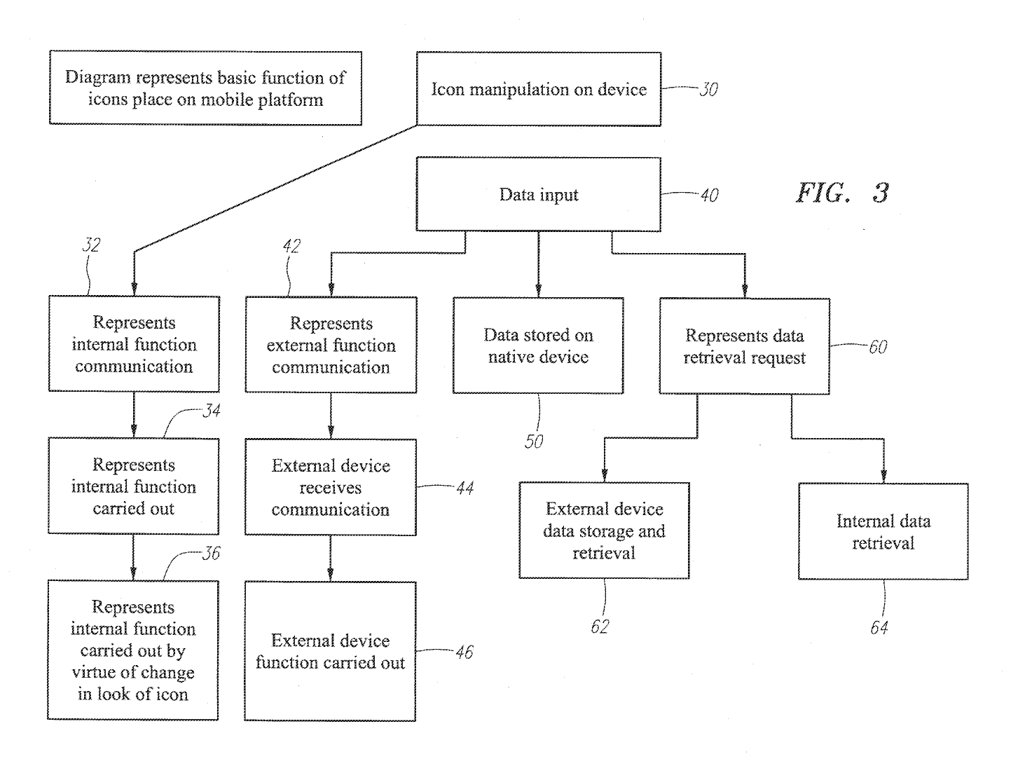

FIG. 3 is a flowchart functional block diagram showing the basic function of icons on a mobile platform. Icon manipulation on the EDDS device (step 30) optionally results in actions which represent internal function communication (step 32). The internal function is caused to be carried out or otherwise effected. (step 34). The shape, style or appearance of the icon may then be changed to indicate that the internal function has been carried out. (step 36). Data input (step 40) may optionally comprise an external function communication (step 42), and/or relate to data stored on the native device (step 50), and/or represent a data retrieval request. (step 60). In the event of an external function communication (step 42), an external device receives communication (step 44), upon which the external device function is carried out. (step 46). In the event of a data retrieval request (step 60), the external device data storage and retrieval is effected (step 62) and/or internal data is retrieved. (step 64).

Icon based documentation can speed data input for numerous reasons. Gesture movement of Icons is simple and represents concepts. It provides a simple method for input of data to an EMR or medical device. Such Icons have wide applicability. The same image can be used for the same action in EMRs or medical devices, which decreases the learning curve and likelihood of mistakes by clinicians who must utilize multiple medical devices or EMRs with unique/proprietary user interfaces.

Icons are also configurable. Icons can be configured to be present or absent by the user, or by the system. The screen displays icons necessary for the function of the device it is utilized upon or the clinical scenario the clinician is engaged in. Clinical documentation is directed by the system and assists the clinician by displaying only screens that are required for care of the patient's problem. Icons translate across languages and settings by providing a symbolic universal language for direct information input or device action. Icons serve to demonstrate, as they can display actions, convey information, and function as device controllers for other devices. Some icons are moved or dragged, indicating not only an action, but for data input. Finally, Icons promote efficiency. Icons represent concepts, data, or device actions and eliminate the need for the user to use multiple keystrokes or actual typing of information.

The user interface utilizes symbolic language in the form of Icons that are standardized in look and configuration and capable of being utilized on any type of EMR or Wireless device. Icon documentation is the only viable option for displaying large sets of data on mobile devices with small displays. The user interface has the ability to control other devices wirelessly including download of data, managing functions of electronic devices, and integrating data into an EMR from a wireless system. Current user interfaces employed on medical devices lack a standardized tool and functionality, which creates complexities for clinicians working with multiple proprietary, based devices. Data management with Icons is an improved method for documentation on mobile devices due to the ability to group functions under specific Icons eliminating the need for multiple key strokes to perform actions.

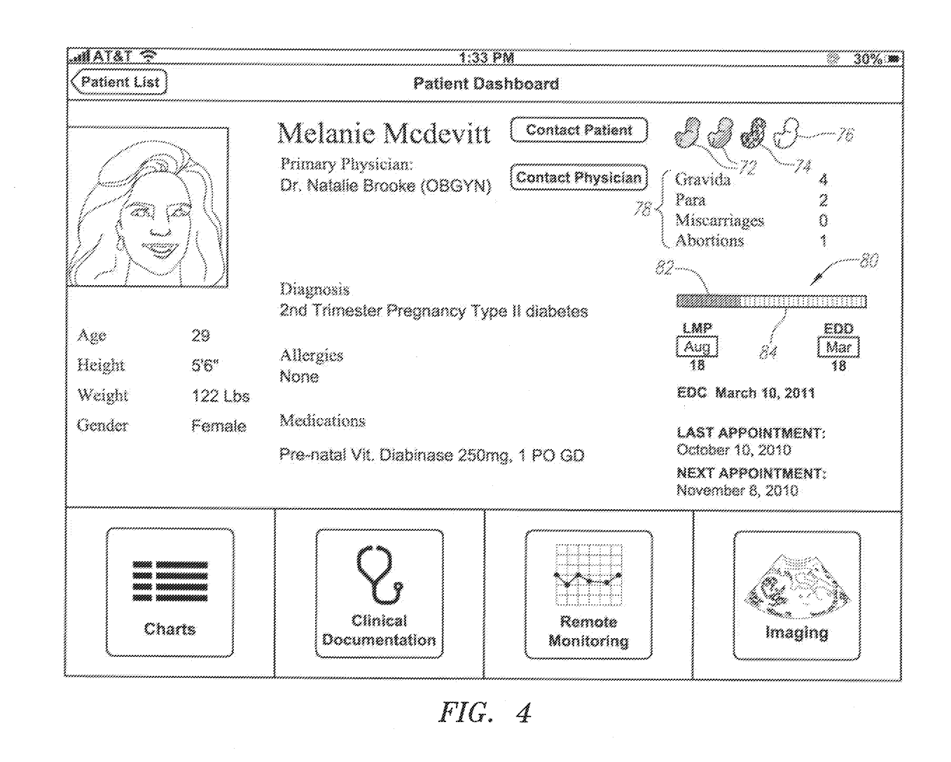

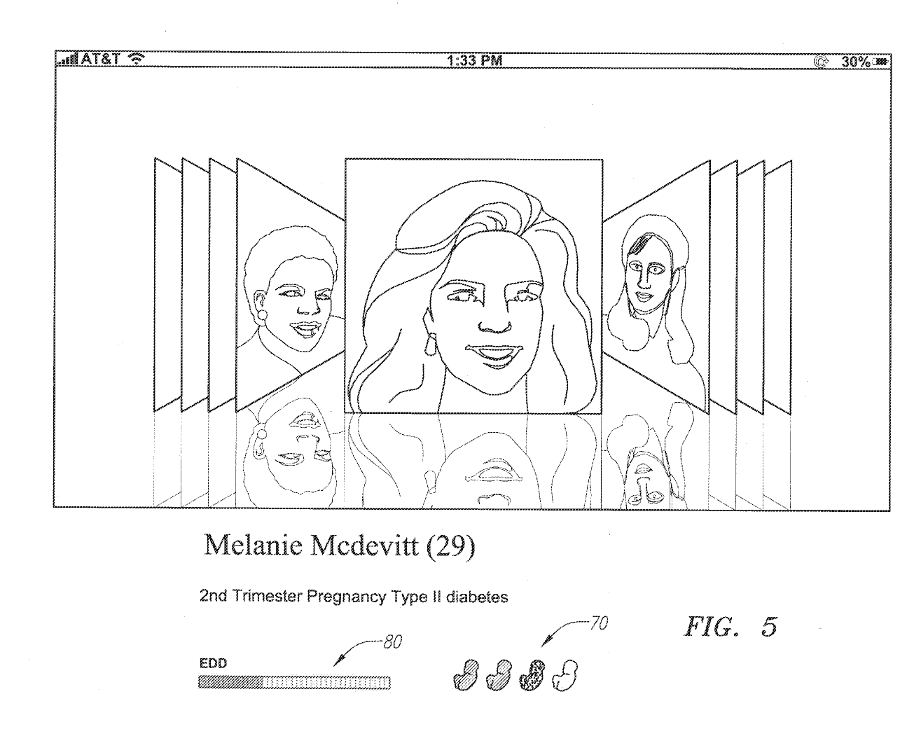

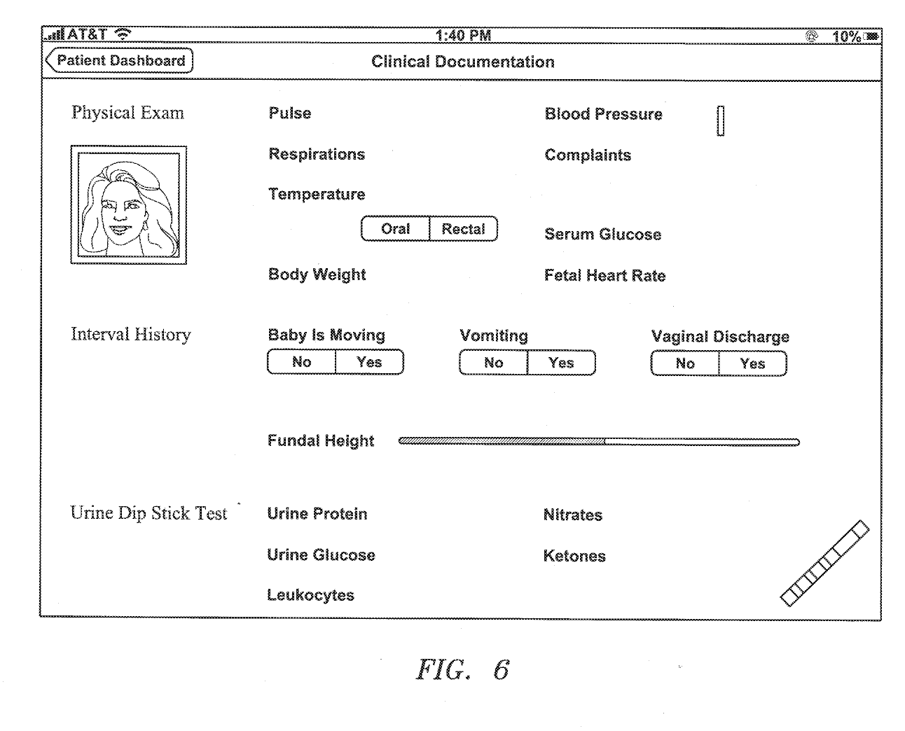

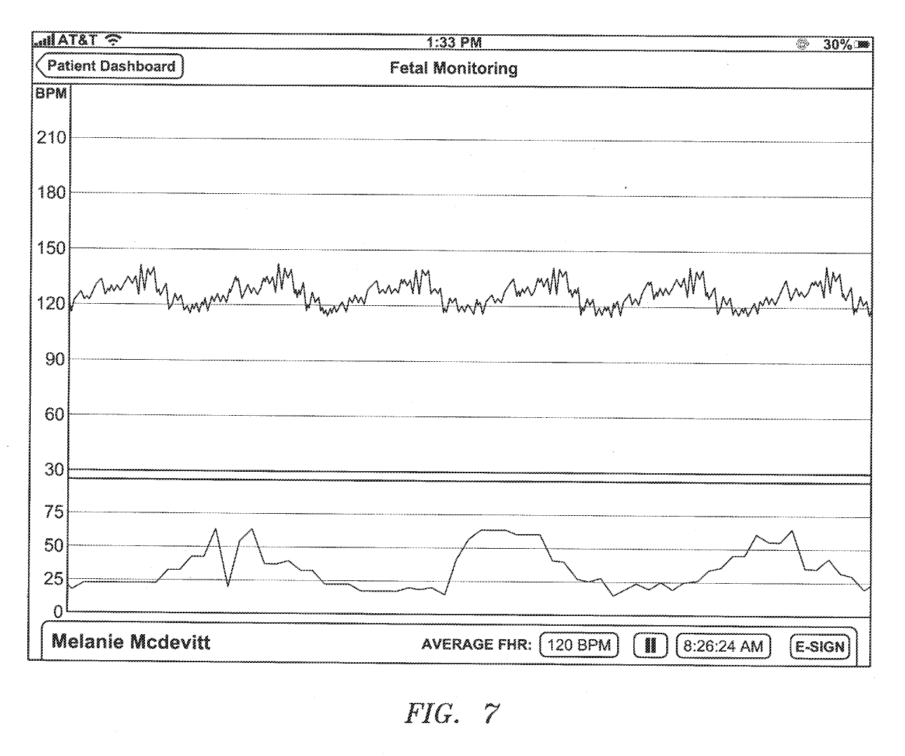

FIGS. 4, 5 and 6 are a representative patient dashboard, patient display of information, and clinical documentation screens, respectively, which employ an icon driven user input system. Exemplary gravida icons 70 show pregnancies. Icons 72 may be of one color, green for example, to indicate prior live births. Icon 74 may be of another color, for example red, to indicate a prior miscarriage or abortion. Icon 76 may be of another color, for example white, to indicate a current pregnancy. Textual description 78 may also be provided in combination with the icons 70. Yet a further icon may include a gestational icon, depicting the current time in gestation (shown by the darker region 82) and an indication of expected future gestational period in another color (shown in clear or white 84). A menu driven set of icons may route to other functions, including but not limited to charts, clinical documentation, remote monitoring or imaging. FIG. 5 further shows a album driven display system for accessing desired pages, functionality or icons. FIG. 6 shows a clinical documentation screen which may be populated with clinical data as entered by a medical professional, and/or as supplied wirelessly from various monitoring or analytical devices. FIG. 7 is a representative patient dashboard displaying the combination of fetal heartbeat and maternal uterine contraction data, such as from EMG electrodes, or other gauge, e.g. strain gauge, to indicate contraction. See, e.g., United States Provisional application entitled “Wireless Fetal Monitoring System”, filed on even date herewith, which is incorporated herein by reference as if fully set forth herein.

The systems and methods achieve data management and clinical decisions by employing algorithms that assist the clinician in visualizing, analyzing, and arriving at conclusions from data sets. This includes suggested diagnosis and medical treatments by the system. The system is capable of providing graphical displays demonstrating interrelationships between clinical data sets. Current EMRs do no have this capability or the ability to provide clinical decision support in the form of recommended diagnosis, clinical treatments, or medical management (based upon data input from the clinician or remote monitoring).

The systems and methods provide a documentation tool by applying algorithms to determine what clinical documentation the clinician requires based on initial data provided by the clinician. The documentation is interactive and prompts the clinician to document based upon defined parameters. This is an improvement over current EMRs that are static screens, which require the clinician to scroll through multiple screens to enter data that may or may not be relevant to the clinical problem.

The system preferably operates from a touch screen computerized device, which is either a mobile platform, or a stationary device. The clinician uses the touch screen to move Icons around a screen to illicit actions on the part of the computerized device. The Icons are moved via touch (finger gesture) or direct stylus gesture input on the computerized screen. While a touch screen computerized device is preferred, other forms of user interface and input output systems may be utilized, including but not limited to a keyboard, a mouse, a smart pen, motion detection devices (such as Microsoft Kinect), and audio control systems.

The Icons are standardized graphical representations, which represent functions, information display, or actions the clinician may carry out or actions the clinician directs the device to carry out. The Icons change representation based upon predefined functions that are unique to the Icons. Change in representation includes color, size, symmetry, or grouping. Such a change in color would represent an action the clinician may take, for example, a graphical Icon representing a diagnostic test, may change color (Red, Green, and Yellow) to denote an alert to the clinician or an action the clinician must take. By moving the icons in preselected directions, the clinician directs the computerized devices to carry out actions, which include documenting information obtained from the patient, other databases or other health care providers. The Icons are moved to illicit order functions that include ordering of medications, treatments, diagnostics, and surgical/medical therapy. The functions include documenting demographics, patient's past medical history, current or past medications, allergies to drugs, substances, or diet, physical examinations, current clinical care including narrative descriptions of care, surgical or medical treatment, observations, assessments, and patient interactions.

The systems and methods allow multiple providers, on different platforms, to access and store information utilizing the Icon documentation regardless of computer platform. The system receives data from multiple sources including databases external to the system and signals to the Icons that data is received and viewable on the platform. The system displays data in either a summary mode (which is data related to all aspects of care and treatment) through predefined user parameters, or a raw data mode that allows the user to see all data non-summarized.

The systems and methods are able to create user definable data sets, which include data from outside sources, data entered by clinician, or data from remote monitoring. The system continuously scans all databases (numerical, narrative, and graphical data) for possible relationships. The system alerts the user to data relationships and displays through a series of alerts to action, suggestions for possible diagnosis, suggestions for treatments, and alerts to medication allergies (or possible drug interactions). The system provides data graphically displayed to represent discrete relationships between data sets.

The system and methods preferably continuously scan all physiological data, diagnostics data and remote monitoring to determine trends that may indicate a serious clinical event in which the patient is showing subtle signs of clinical deterioration. The user is notified by either change in representation of an Icon, audible, or visual alerts (brief narratives), text message, voice messages, email or audible tones from the platform upon which the system resides upon. The system displays data in two modes. In the first mode, the system scans the recorded databases to synthesize information into displayed data in summary form, which can be static narrative or displayed as multiple graphical representations, which facilitate creating new relationships with predefined data parameters. In a second mode, data is displayed showing the entire electronic medical record to articulate relationships between disparate data sets. Additional modes of display are possible by establishing display parameters.

The system operates on an architectural software framework that allows users, operating on different platforms or user interfaces, to access, transfer, download, and share databases. Databases consist of medical information, patient related data, diagnostic data, physiological data, remote monitoring of patients (see FIG. 1B) graphical representations of medical images, pharmaceutical or medical reference data, and demographic/billing data. Interoperability across multiple and varied types of platforms including mobile and fixed computer devices is not restricted by geographical location or software architecture. The system shares data through either electronic wireless means or standard cabled methods. The system receives and sends data to medical devices that carry out functions such as physiological monitoring, medical intravenous infusions, devices that regulate or support a patient's respiratory functions, any device that supports cardiac functions, any devices that receive remote sensor data, or devices that are invasive or noninvasive in nature.

The system can control devices external to the platform (electronically) the system is employed upon. By using gesture input on the EMR, the user can control devices in locations that interact with the patient. The actions of the system on other user-defined devices include, but are not limited to the following: Infusion devices, physiological monitoring, pharmaceutical dispensing devices, devices that control a patient's physiological activity, or any devices that monitor the patient through visual, numerical, video or audio means.

All publications and patents cited in this specification are herein incorporated by reference as if each individual publication or patent application were specifically and individually indicated to be incorporated by reference. Although the foregoing invention has been described in some detail by way of illustration and example for purposes of clarity and understanding, it may be readily apparent to those of ordinary skill in the art in light of the teachings of this invention that certain changes and modifications may be made thereto without departing from the spirit or scope of the following claims.

We claim:

1. A system for clinical decision support comprising:
a user display and input device, the device configured to include symbolic language including icons, the icons being controllable based upon user input,
input data feeds from one or more external databases, and from a user input device,
display presentation system to cohort the data received via the input data feeds,
external device control system for wireless remote control of medical devices, and
a clinical decision support system for providing clinical information to the user.

2. The system for clinical decision support of claim 1 wherein the user display and input device is a touch screen device.

3. The system for clinical decision support of claim 1 wherein the user display and input device is a kinetic motion sensor device.

4. The system for clinical decision support of claim 1 wherein the user display and input device is an audio controlled device.

5. The system for clinical decision support of claim 1 wherein the icons include a gravidia icon.

6. The system for clinical decision support of claim 5 wherein the gravidia icons are of different color based on medical history.

7. The system for clinical decision support of claim 1 wherein clinical decision support system provides a recommendation relating to diagnosis.

8. The system for clinical decision support of claim 1 wherein clinical decision support system provides a recommendation relating to treatment.

9. The system for clinical decision support of claim 1 wherein clinical decision support system provides a recommendation relating to medications.

10. The system for clinical decision support of claim 1 wherein clinical decision support system provides a recommendation relating to medical actions.
